(19) United States
(12) Patent Application Publication
(10) Pub. No.: US 2005/0181218 A1
(43) Pub. Date: Aug. 18, 2005

(54) Glass substrate for information recording media and information recording medium

(75) Inventors: Kouichiro Shiraishi, Tokyo (JP); Mikio Ikenishi, Tokyo (JP); Xuelu Zou, Tokyo (JP)

Correspondence Address: NIXON & VANDERHYE, PC, 901 NORTH GLEBE ROAD, 11TH FLOOR, ARLINGTON, VA, 22203, US

(73) Assignee: Hoya Corporation, Tokyo (JP)

(21) Appl. No.: 10/510,446

(22) PCT Filed: Jun. 2, 2003
(86) PCT No.: PCT/JP03/06955

(30) Foreign Application Priority Data
Jun. 3, 2002 (JP) 2002-161638

(51) Int. Cl. B32B 17/06; C03C 3/076; C03C 3/085

(52) U.S. Cl. 428/426; 501/55; 501/68; 501/69

(57) ABSTRACT

A glass substrate having a high Young's modulus and high rigidity and being suitable particularly as a substrate that is required to have excellent surface smoothness, a high elastic modulus and a high expansion coefficient and which is for an information recording medium, the glass substrate having a surface having a center-line average roughness ratio, Rab/Raf, of 0.8 to 1, in which Raf is a center-line average roughness measured after the glass substrate is held in water having a temperature of 80° C. for 24 hours and Rab is a center-line average roughness Rab measured before the holding, and having a Young's modulus of 90 GPa or more, and an information recording medium having the glass substrate and having an information recording layer formed on the glass substrate.

### BACKGROUND OF THE INVENTION

1. Field of the Invention

The present invention relates to a glass substrate for an information recording medium and an information recording medium. More specifically, the present invention relates to a glass substrate which has a high Young's modulus and high rigidity and which is suitable as a substrate for an information recording medium that is required to have a surface smoothness in particular and have a high elastic modulus and a high expansion coefficient, and an information recording medium comprising the above glass substrate.

2. Prior Art

Main components of a magnetic storage device of a computer or the like include a magnetic recording medium and a magnetic head for reproducing magnetically recorded data. As the former magnetic recording medium, a flexible disk and a hard disk drive are known. Of these, as a hard disk of the hard disk drive, an aluminum alloy has been mainly used. Recently, the flying height of a magnetic head is conspicuously decreasing with downsizing of a hard disk drive and an increase in magnetic recording density. The magnetic disk substrate is accordingly required to have remarkably high accuracy with its surface smoothness. However, an aluminum alloy has a low hardness, and even when a highly accurate abrasive and a machine tool are employed for polishing and lapping the aluminum alloy, it is difficult to form a flat surface having accuracy higher than a certain level, since the polished and lapped surface undergoes plastic deformation. Further, it is also demanded to decrease the thickness of a substrate for a magnetic disk with a decrease in size and thickness of a hard disk drive. Since, however, an aluminum alloy has low strength and low rigidity, it is difficult to decrease the thickness of the disk while retaining a predetermined strength that is required according to the specification of a hard disk drive. Under the circumstances, there have been introduced glass substrates for a magnetic disk that is required to have high strength, high rigidity, high impact resistance and high surface smoothness. Of these, a chemically strengthened glass substrate having a surface strengthened by an ion-exchange method and a crystallized glass substrate obtained by crystallization are commercially available.

However, hard disks are recently being downsized, decreased in size and increased in recording density, so that the flying height of a magnetic disk is rapidly decreasing and the rotation speed of a disk is rapidly increasing. A disk substrate material is therefore demanded to satisfy severe strength, Young's modulus and surface smoothness. Particularly, with an increase in the information recording density of a hard disk for a personal computer and a server, a substrate material is recently demanded to satisfy a severe surface smoothness and a severe surface flatness. Further, with an increase in the speed of data processing, the number of rotation of a disk is required to be 10,000 rpm or more, so that a substrate material is demanded to satisfy severer rigidity, and it has come to be clear that the conventional aluminum substrate has limits. So long as an increase in the capacity of the hard disk and an increase in the speed of rotation thereof are inevitable in the future, a substrate material for a magnetic recording medium is to be intensely required without doubt to have a high Young's modulus, high hardness, excellent surface flatness and surface smoothness, an excellent impact resistance, and the like.

Meanwhile, commercially available chemically strengthened glass has a Young's modulus of approximately 80 GPa, and it is clear that such a glass can no longer cope with severe demands that a hard disk is to satisfy in the future. A commercially available crystallized glass has a high Young's modulus of approximately 90 GPa. However, since crystal grains of different phase species are present inside a material, a convexoconcave shape formed of the crystal grains remains on the surface of the polished material, and the crystallized glass has a defect that it has poor surface smoothness as compared with a chemically strengthened glass.

Further, a substrate made of an amorphous glass is demanded to have high water resistance for attaining excellent surface smoothness. When a substrate has no sufficient water resistance, the smoothness of the substrate surface decreases when the substrate is washed, and such a substrate can no longer satisfy any high surface smoothness that a substrate for an information recording medium is required to have in the future.

One of the present inventors has proposed a substrate for an information recording medium, which is made of a glass having a high Young's modulus (100 GPa or more) for coping with an increase in the rotation speed and having a liquidus temperature of 1,350° C. or lower (WO98/55993). Since the above substrate for an information recording medium has a remarkably high Young's modulus, a small flying height (distance between a magnetic head and a magnetic disk during recording and reproduction) can be secured during high-speed rotation.

By imparting the above glass substrate having a high Young's modulus with water resistance to form a substrate excellent in surface smoothness, there can be obtained a substrate for an information recording medium, which can fully satisfy the above demanded properties.

### SUMMARY OF THE INVENTION

Under the circumstances, it is an object of the present invention to provide a glass substrate that is suitable as a substrate for an information recording medium which substrate required to have excellent surface smoothness and which has a high Young's modulus and high rigidity, a glass substrate having a high expansion coefficient, and an information recording medium to which the above substrate is applied.

For achieving the above object, the present inventors have made diligent studies and found that the above object can be achieved by a glass substrate when the ratio of a center-line average roughness of the surface thereof after the glass substrate is held in water under certain conditions and a center-line average roughness of the surface before the holding is in a specific range. The present invention has been completed on the basis of the above finding.

That is, the present invention provides;
(1) a glass substrate for an information recording medium, the glass substrate having a surface having a center-line average roughness ratio, Rab/Raf, of 0.8 to 1, in which Raf is a center-line average roughness measured after the glass substrate is held in water having a temperature of 80° C. for 24 hours and Rab is a center-line average roughness Rab measured before the holding, and the glass substrate having a Young's modulus of 90 GPa or more,
(2) a glass substrate for an information recording medium as recited in the above (1), which has a glass composition consisting essentially of SiO₂, Al₂O₃, Li₂O, Na₂O, MgO, CaO, TiO₂ and ZrO₂,
(3) a glass substrate for an information recording medium as recited in the above (2), wherein the glass composition contains, by mol %, more than 50% but not more than 70% of SiO₂, at least 1% but less than 6% of Al₂O₃, more than 12% but not more than 25% of Li₂O, at least 1% but less than 3% of Na₂O, 0 to less than 15% of MgO, 1 to 30% of CaO, more than 0.1% but less than 5% of TiO₂, and more than 3% but not more than 10% of ZrO₂,
(4) a glass substrate for an information recording medium as recited in any one of the above (1) to (3), which is chemically strengthened,
(5) a glass substrate for an information recording medium as recited in the above (1) to (4), which has an average linear expansion coefficient, measured at 100 to 300° C., of at least 80×10⁻⁷/° C., and
(6) an information recording medium comprising an information recording layer formed on the glass substrate recited in any one of the above (1) to (5).

### PREFERRED EMBODIMENTS OF THE INVENTION

The glass substrate for an information recording medium, provided by the present invention, will be explained first.

The glass substrate of the present invention has excellent water resistance, and the water resistance can be represented by a center-line average roughness Rab/Raf, in which Raf is a center-line average roughness measured after the glass substrate is held in water having a temperature of 80° C. for 24 hours and Rab is a center-line average roughness Rab measured before the holding. In the present invention, the value of the above Rab/Raf is 0.8 to 1. A glass substrate having an Rab/Raf value closer to 1 has better water resistance, and such a glass substrate shows a less degradation of the surface roughness. The value of the Rab/Raf is preferably 0.84 to 1. The center-line average roughness before the glass substrate is held in water as described above is preferably in the range of 0.1 to 0.5 mm. The above Rab and Raf can be measured by means of an atomic force microscope (AFM).

The glass substrate of the present invention has the above property and also has high rigidity or a Young's modulus of at least 90 GPa, more preferably at least 95 GPa. For example, the glass composition can be determined in a manner that the glass substrate has a Young's modulus of 90 to 120 GPa, more preferably 95 to 120 GPa.

There can be according provided a glass substrate that can be applied to an information recording medium excellent in stability during high-speed rotation and which has remarkably high surface smoothness.

Preferably, the above substrate has an average linear expansion coefficient, measured at 100 to 300° C., of 80×10⁻⁷/° C. Since an information recording medium is incorporated into a disk drive, it is preferred to adjust the average linear expansion coefficient of the glass substrate in the above range to an average linear expansion coefficient of a support material on the disk drive side.

Further, the glass substrate of the present invention preferably has a specific gravity of 3.1 or less, more preferably 2.9 or less while it satisfies the above water resistance, the above Young's modulus and the above expansion coefficient. The composition of glass may be selected so that the glass has the specific gravity of 2.3˜2.9.

The above glass substrate preferably has a glass composition consisting essentially of SiO₂, Al₂O₃, Li₂O, Na₂O, MgO, CaO, TiO₂ and ZrO₂. Above all, the above glass composition preferably contains, by mol %, more than 50% but not more than 70% of SiO₂, at least 1% but less than 6% of Al₂O₃, more than 12% but not more than 25% of Li₂O, at least 1% but less than 3% of Na₂O, 0 to less than 15% of MgO, 1 to 30% of CaO, more than 0.1% but less than 5% of TiO₂, and more than 3% but not more than 10% of ZrO₂ (contents of glass components hereinafter refer to contents by mol % unless otherwise specified).

The reason why the above glass composition is preferred will be explained below. Parenthesized values below refer to preferred contents by weight percentage (% by weight).

SiO₂ is a main component for forming a glass network structure, and the lower limit of the content thereof is determined by taking account of the durability, crystallization resistance and high-temperature formability of a glass. The upper limit thereof is determined by taking account of the Young's modulus and expansion coefficient of the glass. The content of SiO₂ is preferably more than 50% but not more than 70% (more than 30% by weight but less than 66% by weight). The content of SiO₂ is more preferably more than 50% but less than 65% (more than 30% by weight but less than 66% by weight), more preferably more than 55% but less than 63%.

Al₂O₃ is a component required for strengthening the glass network structure and improving the durability of the glass. It is also a component that prevents roughening of a glass surface when the glass substrate is washed by immersing it in water. The lower limit of the content thereof is determined by taking account of the durability of the glass and the prevention of surface roughening during washing. The upper limit thereof is determined by taking account of formability that may be degraded by an increase in liquidus temperature. The content of Al₂O₃ is preferably at least 1% but less than 6% (less than 12% by weight), more preferably at least 1% but less than 6% (less than 12% by weight), more preferably less than 11% by weight, still more preferably less than 10% by weight.

Li₂O is a component essential for decreasing the melting temperature of the glass to improve meltability and is also a component that undergoes ion-exchange in chemical strengthening, and the lower limit of the content thereof is therefore determined by taking account of these points. It is required to determine the upper limit of the content thereof by taking account of the devitrification resistance of the glass. The content of Li₂O is preferably more than 12% but not more than 25% (more than 3% by weight), more preferably more than 12% but not more than 25% (more than 3% by weight), still more preferably at least 13% (more than 4% by weight).

Na₂O is an essential component, and like Li₂O, it is a component for decreasing the melting temperature of the glass to improve meltability and is also a component that undergoes ion-exchange in chemical strengthening. When the content thereof is too large, the Young's modulus and chemical durability are degraded. It is therefore preferred to adjust the content of Na₂O to at least 1% but less than 3% (less than 4% by weight).

CaO is an essential component for improving the glass in Young's modulus, meltability and devitrification resistance. When the content thereof is too large, the liquidus temperature increases, and the glass may be degraded in meltability and devitrification resistance. It is therefore preferred to adjust the content of CaO to 1 to 30% (at least 5% by weight).

MgO is a component useful for improving the glass in Young's modulus. When the content thereof is too large, the liquidus temperature of the glass increases, and further, the glass may be degraded in devitrification resistance. The content of MgO is therefore preferably 0% to less than 15% (less than 12% by weight), more preferably less than 10% (not more than 11% by weight).

In view of an improvement in Young's modulus, meltability and devitrification resistance, the total content of CaO and MgO is desirably 2 to 30%.

ZrO₂ and TiO₂ are essential components for improving the glass in Young's modulus and durability, and the lower limit of the content of each is determined by taking account of the above properties. When the contents of TiO₂ and ZrO₂ are too large, the liquidus temperature increases, and the high-temperature meltability of the glass is degraded, so that the upper limit of the content of each determined by taking account of these properties. The content of ZrO₂ is preferably more than 3% but not more than 10% (more than 6% by weight), more preferably at least 3.5% (more than 7% by weight).

Preferably, the content of TiO₂ is smaller than the content of ZrO₂ for accomplishing the object of the present invention. Specifically, the content of TiO₂ is preferably more than 0.1% but less than 5% (less than 10% by weight).

Further, when the above improvement in Young's modulus, a decrease in the liquidus temperature and an improvement in high-temperature meltability are taken into account, it is preferred to adjust the total content of ZrO₂ and TiO₂ to 20% or less.

In addition, Sb₂O₃ and As₂O₃ may be added as a clarifier. When the above clarifier is added, it is desirable to add Sb₂O₃ alone in view of a detrimental effect on environments. The content of the clarifier based on the glass composition is desirably less than 1%, and it is preferably 0 to less than 1% for obtaining an anti-foaming effect.

B₂O₃ has the effect on decreasing the liquidus temperature of the glass when added in a small amount. However, when the content thereof increases, the Young's modulus may sharply decrease, so that it is required to take care when B₂O₃ is introduced. The glass substrate of the present invention can be imparted with excellent devitrification resistance and a high Young's modulus without containing B₂O₃. It is therefore desirable not to introduce B₂O₃ that may sharply decrease the Young's modulus when introduced.

When an ion-exchange efficiency is taken into account, desirably, the content of K₂O is 0.1% or less, and it is more desirable to introduce no K₂O.

Each of SrO and BaO works to improve the glass in devitrification resistance and expansion coefficient and to decrease the liquidus temperature of the glass. However, these components increase the specific gravity of the glass and decrease the Young's modulus of the glass. It is therefore preferred to introduce none of these oxides.

Y₂O₃ and La₂O₃ have a great effect on improving the glass in Young's modulus and water resistance. However, when they are introduced, the glass increases in weight and is degraded in stability. The glass substrate of the present invention can be imparted with a high Young's modulus and excellent water resistance without containing rare earth oxides such as Y₂O₃ and La₂O₃. It is therefore preferred to introduce none of Y₂O₃ and La₂O₃ by making much account of the stability of the glass. It is also preferred not to introduce any other rare earth oxides.

Concerning any other components, it is desirable to incorporate no PbO by taking account of its environmental effect. ZnO, P₂O₅, SnO₂, CeO₂ and F are unnecessary components.

A preferred composition of the glass substrate of the present invention can be realized on the basis of a combination of the above preferred contents of the components.

The glass substrate of the present invention is formed of a glass that in principle contains no crystal phase (glass formed of an amorphous phase).

The glass substrate of the present invention is suitable for chemical strengthening. The chemical strengthening is carried out by immersing the glass substrate in a molten salt containing Na ion and/or K ion. The temperature of the molten salt can be set at a temperature higher than the distortion point of the glass and equivalent to, or lower than, the glass transition temperature Tg. When the temperature of the molten salt is too low, it is difficult to form a compression stress layer in the substrate surface, and the chemical strengthening produces no sufficient effect. When the temperature of the molten salt is too high, the glass substrate may be deformed.

In the chemical strengthening, Li ion and Na ion in the glass undergo ion-exchange with Na ion and/or K ion in the molten salt, to form a compression stress layer, whereby the destructive strength of the glass can be increased so that it is several times as large.

In view of the above chemical strengthening step and/or the step of forming an information recording medium, it is desirable to adjust the glass transition temperature Tg of the glass substrate material to 500° C. or higher. When the glass transition temperature is too low, there is caused a problem that salts to be used for the chemical strengthening such as sodium nitrate and potassium nitrate cannot be melted under the above temperature conditions, or that the glass substrate is deformed by heating employed for forming an information recording layer on the glass substrate. The glass composition can be determined such that the glass substrate material has a glass transition temperature Tg of 500 to 600° C. by taking account of the above points.

The Young's modulus, the above expansion coefficient, the glass transition temperature, the specific gravity, etc., which the glass substrate has before the chemical strengthening almost do not change after the chemical strengthening. The Rab/Raf is unchanged or increases after the chemical strengthening (the upper limit thereof is 1).

The chemical strengthening step is as described already. The steps of producing the substrate and the information recording medium will be explained below.

A homogeneous molten glass containing no bubbles is prepared by a high-temperature melting method, that is, by melting predetermined amounts of glass materials in air or in an inert gas atmosphere and homogenizing a formed glass by bubbling or stirring. Then, the above molten glass is shaped into a sheet glass by any one of a known pressing method, a known down-drawing method and a known floating method, and the sheet glass is gradually cooled. Then, the sheet glass is subjected to the processing of the sheet glass to make a circular form, the making of a central hole, the processing of inner and outer side surfaces, and polishing and lapping, to form a substrate for an information recording medium, the substrate having a desired size and form. The polishing and lapping is carried out by lapping with an abrasive or diamond pellets and polishing with an abrasive such as cerium oxide, whereby the surface on which an information recording layer is to be formed is finished such that it is flat and smooth. By the polishing and lapping, there can be formed a surface having a surface accuracy in the range of 0.1 to 0.6 nm. The above chemical strengthening step may be carried out before or after the lapping step. According to the glass substrate of the present invention, the surface roughness caused by washing after the polishing and lapping is decreased, and not only remarkably high smoothness can be maintained, but also the re-adherence of an elution matter during washing can be decreased.

The method of producing the information recording medium of the present invention will be explained below.

The information recording medium of the present invention comprising an information recording layer formed on the above glass substrate for an information recording medium. For example, when a magnetic recording medium (magnetic disk) is formed, an undercoat layer, a magnetic layer (information recording layer), a protective layer and a lubricant layer are consecutively formed on the glass substrate. Although not specially limited, the magnetic layer is preferably a magnetic layer formed of a Co—Cr system, a Co—Cr—Pt system, a Co—Ni—Cr system, a Co—Ni—Pt system, a Co—Ni—Cr—Pt system or a Co—Cr—Ta system. The undercoat layer includes an Ni layer, an Ni—P layer and a Cr layer. The protective layer includes a carbon film, and a lubricating material containing a perfluoropolyether or the like may be used for forming the lubricant layer. The above layers may be of known layers.

The glass substrate for an information recording medium, provided by the present invention, is not only suitable as a substrate for a magnetic recording medium but also suitable as a substrate for various information recording media such as a magneto-optical recording medium and an optical disk. There can be therefore provided various information recording media such as a magneto-optical recording medium and an optical disk by selecting information recording layers so as to meet corresponding various recording methods.

### EXAMPLES

The present invention will be explained more in detail with reference to Examples hereinafter, while the present invention shall not be limited by these Examples.

### Examples 1-11 and Comparative Example 1

SiO₂, Al₂O₃, Al(OH)₃, MgO, Mg(OH)₂, MgCO₃, CaCO₃, Li2CO3, Na₂CO₃, TIO₂, ZrO₂, and the like as starting materials weighed so as to obtain a composition shown in Table 1 or 2 and fully mixed to prepare a formulated batch. The formulated batch was placed in a platinum crucible and melted in air at a temperature of 1,400 to 1,600° C. for approximately 3 to 8 hours. The resultant molten glass was flowed into a carbon mold having a size of 40×40×20 mm, allowed to cool to a glass transition temperature and, immediately thereafter, placed in an annealing furnace. The glass was held therein for 1 hour and allowed to cool to room temperature in the furnace. In the thus-obtained glass, there was precipitated no crystal that was observable through a microscope.

The thus-obtained glass was machined to prepare 40×20×15 mm, 5φ×20 mm and 30×30×2 mm samples for evaluations of physical properties, and the samples were measured for physical properties according to the following methods. Table 1 shows the glass compositions (mol %) and physical properties in Examples 1˜6 and Table 2 shows the glass compositions (% by weight) in Examples 1˜6 calculated based on the glass compositions (mol %) described in Table 1. Table 3 shows the glass compositions (mol %) and physical properties in Examples 7˜11 and Comparative Example 1 and Table 4 shows the glass compositions (% by weight) in Examples 7•11 and Comparative Example 1 calculated based on the glass compositions (mol %) described in Table 3.

(1) Glass Transition Temperature (Tg)

A 5 mmφ×20 mm sample was measured with a thermo-mechanical analyzer (TMA8140) supplied by Rigakusha at a temperature elevation rate of +4° C./minute. SiO₂ was used as a standard sample.

(2) Average Linear Expansion Coefficient

The average linear expansion coefficient means an average linear expansion coefficient at 100 to 300° C., and the measurement thereof was made during the measurement of the glass transition temperature.

(3) Specific Gravity

A 40×20×15 mm sample was measured according to an Archimedean method.

(4) Young's Modulus

A 40×20×15 mm sample was measured according to an ultrasonic method.

(5) Alkali Elution Amount

A 30×30×2 mm sample ultrasonically washed in an ethanol bath was first measured for an average roughness (Rab) with an atomic force microscope (AFM). Then, the sample was placed in a polypropylene container that had been washed with an acid beforehand, and the sample was weighed to obtain a dry mass. Approximately 20 ml of 80° C. ultrapure water was added to the container, and the container with a cover was placed in an oven at 80° C. and allowed to stand for 24 hours. Then, the door of the oven was half-opened to switch off electricity, the sample was allowed to cool for 30 minutes, and the container was taken out of the oven. After the treatment, the container was weighed, and then the glass was taken out, to give a sample solution. A solution amount was defined to be a value obtained by deducting a dry mass from a weighed value after the treatment. Eluted elements were determined by means of ICP-AES (ICP emission spectroscopy analyzer “VISTA AX” supplied by Barian).

(6) Rab/Raf

The glass (sample) taken from the container after completion of the treatment in the above (5) was dried and measured for an average roughness (Raf) with an atomic force microscope (AFM), and a ratio of Rab to Raf (Rab/Raf) was calculated. A value closer to 1 means higher water resistance.

TABLE 1

| | | Examples | | | | | |
|---|---|---|---|---|---|---|---|
| | | 1 | 2 | 3 | 4 | 5 | 6 |
| Glass Composition (mol %) | SiO₂ | 57.0 | 58.0 | 58.0 | 58.0 | 58.0 | 58.0 |
| | Al₂O₃ | 5.0 | 4.0 | 4.0 | 4.0 | 5.0 | 5.0 |
| | Li₂O | 14.0 | 14.0 | 14.0 | 15.0 | 15.0 | 15.0 |
| | Na₂O | 2.0 | 2.0 | 2.0 | 2.0 | 2.0 | 2.0 |
| | MgO | 6.0 | 6.0 | 5.0 | 6.0 | 5.0 | 6.0 |
| | CaO | 10.0 | 10.0 | 10.0 | 8.0 | 8.0 | 8.0 |
| | TiO₂ | 1.0 | 1.0 | 2.0 | 2.0 | 2.0 | 1.0 |
| | ZrO₂ | 5.0 | 5.0 | 5.0 | 5.0 | 5.0 | 5.0 |
| | K₂O | — | — | — | — | — | — |
| | Zno | — | — | — | — | — | — |
| | Total | 100.0 | 100.0 | 100.0 | 100.0 | 100.0 | 100.0 |
| physical | Glass transition temperature (° C.) | 556 | 540 | 543 | 541 | 550 | 539 |
| properties | Average linear expansion coefficient | 82.5 | 80.8 | 82.2 | 87.7 | 88.3 | 87.3 |
| | [100-300° C.] (×10⁻⁷/° C.) | | | | | | |
| | Specific gravity | 2.719 | 2.717 | 2.724 | 2.710 | 2.701 | 2.700 |
| | Young's modulus (GPa) | 99.97 | 99.49 | 99.72 | 99.68 | 99.07 | 99.05 |
| | Alkali elution amount (μmol/cm²) | 0.152 | 0.155 | 0.181 | 0.259 | 0.216 | 0.210 |
| | Rab/Raf | 0.850 | 0.940 | 0.910 | 0.900 | 0.850 | 0.860 |

TABLE 2

| | | Examples | | | | | |
|---|---|---|---|---|---|---|---|
| | | 1 | 2 | 3 | 4 | 5 | 6 |
| Glass Composition | SiO₂ | 57.33 | 58.75 | 58.36 | 58.77 | 58.17 | 58.55 |
| (% by weight) | Al₂O₃ | 8.53 | 6.88 | 6.83 | 6.88 | 8.51 | 8.57 |
| | Li₂O | 6.98 | 7.03 | 6.98 | 7.54 | 7.46 | 7.51 |
| | Na₂O | 2.08 | 2.09 | 2.08 | 2.09 | 2.07 | 2.08 |
| | MgO | 4.05 | 4.08 | 3.37 | 4.08 | 3.36 | 4.06 |
| | CaO | 9.39 | 9.45 | 9.39 | 7.57 | 7.49 | 7.54 |
| | TiO₂ | 1.34 | 1.35 | 2.68 | 2.69 | 2.67 | 1.34 |
| | ZrO₂ | 10.31 | 10.38 | 10.31 | 10.39 | 10.28 | 10.35 |

TABLE 3

| | | | | | | | Comparative |
|---|---|---|---|---|---|---|---|
| | | Examples | | | | | Example |
| | | 7 | 8 | 9 | 10 | 11 | 1 |
| Glass Composition (mol %) | SiO₂ | 58.0 | 57.0 | 56.0 | 57.0 | 57.0 | 72.4 |
| | Al₂O₃ | 5.0 | 4.0 | 5.0 | 4.0 | 4.0 | 0.6 |
| | Li₂O | 15.0 | 15.0 | 14.0 | 14.0 | 14.0 | — |
| | Na₂O | 2.0 | 2.0 | 2.0 | 2.0 | 2.0 | 9.0 |
| | MgO | 6.0 | 2.0 | 2.0 | 2.0 | 2.0 | — |
| | CaO | 7.0 | 13.0 | 15.0 | 15.0 | 14.0 | 7.0 |
| | TiO₂ | 2.0 | 3.0 | 2.0 | 2.0 | 3.0 | — |
| | ZrO₂ | 5.0 | 4.0 | 4.0 | 4.0 | 4.0 | — |
| | K₂O | — | — | — | — | — | 9.0 |
| | ZnO | — | — | — | — | — | 2.0 |
| | Total | 100.0 | 100.0 | 100.0 | 100.0 | 100.0 | 100.0 |
| Physical | Glass transition temperature (° C.) | 545 | 545 | 550 | 545 | 553 | — |
| Properties | Average linear expansion coefficient | 90.3 | 87.0 | 89.2 | 86.7 | 87.8 | — |
| | [100-300° C.](×10⁻⁷/° C.) | | | | | | |
| | Specific gravity | 2.698 | 2.724 | 2.731 | 2.729 | 2.735 | — |
| | Young's modulus (GPa) | 99.08 | 99.40 | 99.53 | 99.11 | 99.64 | 79.00 |
| | Alkali elution amount (μmol/cm²) | 0.214 | 0.150 | 0.243 | 0.163 | 0.158 | — |
| | Rab/Raf | 0.840 | 0.840 | 0.870 | 0.850 | 0.880 | 0.21 |

Note:
Comparative Example 1 above shows data for the strengthened glass disclosed in JP-A-239036/1989.

TABLE 4

| | | | | | | | Comparative |
|---|---|---|---|---|---|---|---|
| | | Examples | | | | | Example |
| | | 7 | 8 | 9 | 10 | 11 | 1 |
| Glass | SiO₂ | 58.32 | 57.60 | 56.17 | 57.58 | 57.35 | 68.27 |
| Composition | Al₂O₃ | 8.53 | 6.86 | 8.51 | 6.86 | 6.83 | 0.96 |
| (% by | Li₂O | 7.48 | 7.52 | 6.96 | 7.01 | 6.98 | — |
| weight) | Na₂O | 2.07 | 2.09 | 2.07 | 2.08 | 2.08 | 8.75 |
| | MgO | 4.05 | 1.36 | 1.35 | 1.35 | 1.35 | — |
| | CaO | 6.57 | 12.26 | 14.04 | 14.14 | 13.15 | 6.16 |
| | TiO₂ | 2.67 | 4.03 | 2.67 | 2.69 | 4.01 | — |
| | ZrO₂ | 10.31 | 8.29 | 8.22 | 8.28 | 8.25 | — |
| | K₂O | — | — | — | — | — | 13.30 |
| | ZnO | — | — | — | — | — | 2.55 |

As is clearly shown in Tables 1 and 2, the glass substrates in Examples 1 to 11 had high Young's moduli of 90 GPa or more and exhibited average linear expansion coefficients, measured at 100 to 300° C., of 80×10⁻⁷/° C. or more or suitable values. Further, it is seen that the alkali elution amount was as small as 0.3 μmol/cm² or less, and that the surface roughness ratio (Rab/Raf) was 0.8 or more.

In contrast, the glass in Comparative Example 1 has a low Young's modulus of 79 and also has a small roughness ratio (Rab/Raf) of 0.21, so that it is clear that the glass in Comparative Example 1 is not compatible with any high-density-recording and high-speed-rotation hard disk.

According to the glass of the present invention, therefore, there can be provided a glass substrate that has high rigidity and excellent surface smoothness and which is for a magnetic recording medium, so that the glass of the present invention is suitable for producing a high-density high-speed-rotation magnetic recording medium.

Substrate blanks were formed from the glasses having excellent properties as a substrate material for a magnetic recording medium, in Examples 1 to 11. The substrate blanks were gradually cooled and machined to form disks having a predetermined size, and both the surfaces of the disks were polished and lapped to prepare flat and smooth glass substrates. The above-obtained glass substrates were immersed in a molten salt containing a mixture of sodium nitrate and potassium nitrate (the molten salt was set at a temperature higher than their distortion points and equivalent to, or lower than, their glass transition temperatures) to chemically strengthen the glass substrates. It was found that the chemically strengthened glass substrates corresponding to the glasses in Examples and non-chemically strengthened glass substrates gave results equivalent to properties shown in Table 1. These glass substrates were washed, and as a result, no surface roughening was observed, and no adhering matter was found.

An undercoat layer, a magnetic layer, a protective layer, a lubricating layer, etc., were formed on each of the above glass substrates, to obtain magnetic recording media.

The above explanation has been made with regard to a substrate for a magnetic recording medium and a magnetic recording medium having such a substrate, while the glass substrate of the present invention can be applied to substrates for other information recording media such as magneto-optical and optically recording media.

### EFFECT OF THE INVENTION

The glass substrate for an information recording medium, provided by the present invention, has excellent water resistance, so that it has remarkably high durability against the degradation of surface smoothness, and it has a high Young's modulus, so that it is suitable as a glass substrate for an information recording medium whose deformation during high-speed rotation is remarkably less.

The glass substrate of the present invention is particularly suitable as a glass substrate containing alkali metal oxide(s) for chemical strengthening.

Further, according to the present invention, the glass substrate has high rigidity and high surface smoothness, so that the present invention can make the most of such properties to provide an information recording medium suitably compatible with higher-speed rotation and higher-density recording.

1. A glass substrate for an information recording medium, the glass substrate having a surface having a center-line average roughness ratio, Rab/Raf, of 0.8 to 1, in which Raf is a center-line average roughness measured after the glass substrate is held in water having a temperature of 80° C. for 24 hours and Rab is a center-line average roughness Rab measured before the holding, and the glass substrate having a Young's modulus of 90 GPa or more.

2. The glass substrate for an information recording medium as recited in claim 1, which has a glass composition consisting essentially of SiO₂, Al₂O₃, Li₂O, Na₂O, MgO, CaO, TiO₂ and ZrO₂.

3. The glass substrate for an information recording medium as recited in claim 2, wherein the glass composition contains, by mol %, more than 50% but not more than 70% of SiO₂, at least 1% but less than 6% of Al₂O₃, more than 12% but not more than 25% of Li₂O, at least 1% but less than 3% of Na₂O, 0 to less than 15% of MgO, 1 to 30% of CaO, more than 0.1% but less than 5% of TiO₂, and more than 3% but not more than 10% of ZrO₂.

4. The glass substrate for an information recording medium as recited in claim 1, which is chemically strengthened.

5. The glass substrate for an information recording medium as recited in claim 1, which has an average linear expansion coefficient, measured at 100 to 300° C., of at least 80×10₋₇/° C.

6. An information recording medium comprising an information recording layer formed on the glass substrate recited in claim 1.
